(19) United States
(12) Patent Application Publication
(10) Pub. No.: US 2006/0259807 A1
(43) Pub. Date: Nov. 16, 2006

(54) Method and apparatus for clock synchronization between a processor and external devices

(75) Inventors: Howard G. Sachs, Los Altos, CA (US); Richard W. Dickson, Sunnyvale, CA (US); Luigi Di Gregorio, San Jose, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Telairity Semiconductor, Inc., Santa Clara, CA (US)

(21) Appl. No.: 11/126,500

(22) Filed: May 10, 2005

(51) Int. Cl. G06F 1/04

(52) U.S. Cl. 713/500

(57) ABSTRACT

An external data signal serves as the basis for clocking a processor. In particular, a processor clock signal is generated from the external data signal which has a frequency that is an integer multiple of the frequency (data rate) of the external data signal. In this way, metastable conditions arising from different clock signals can be avoided.

### CROSS-REFERENCE TO RELATED APPLICATIONS

The present invention is related to the following commonly owned, applications:
DIRECT MEMORY ACCESS (DMA) METHOD AND APPARATUS AND DMA FOR VIDEO PROCESSING, filed concurrently herewith (attorney docket no. 021111-001500US); and
VECTOR PROCESSOR WITH SPECIAL PURPOSE REGISTERS AND HIGH SPEED MEMORY ACCESS, filed concurrently herewith (attorney docket no. 021111-001300US)
   all of which are incorporated herein by reference for all purposes.

### BACKGROUND OF THE INVENTION

The present invention relates generally to data processors, and in particular to synchronizing the timing of a data processor and an external device.

A typical computer system (e.g., a personal computer) includes a microprocessor chip and various external devices such as system logic, memory, controllers (disk, USB, etc.), and other devices. As shown in FIG. 7A, an oscillator chip usually provides the system with a clock signal (system clock, timing signals, clock, etc.) to coordinate operations among the various devices. FIG. 7B shows a clock driver circuit that is commonly used to distribute the clock signal. Different parts of the system operate at different speeds; the processor typically operates at a much higher clock rate than an I/O controller, for example. Synchronizing the timing among these components can be challenging. As clock frequencies continue to increase, conditioning circuits such as the clock driver are needed to ensure a clean clock signal.

The problem is exacerbated if a device external to the computer system operates on a separate clock altogether. For example, FIGS. 7A and 7B show a data source operating at a clock rate that is different from the clock rate of the processor. In such a case, the clock signals may be phase shifted with respect to each other. For example, in a video processing system such as a video encoder, the frequency of an incoming video signal is fixed by industry-defined standards. Conventionally, a synchronizer circuit is used to synchronize the incoming video signal with a clock signal used to drive the computer system performing the video processing.

All synchronizer circuits suffer from a meta-stability problem which is a statistical artifact in the behavior of these circuit that result in an error. Moreover, it is not a question of whether the error will occur, but when it will occur; the only uncertainty is how long it will take to occur. Meta-stability arises when the two signal edges being synchronized are sufficiently close to one another that the synchronizer does not have enough gain to respond to the input and consequently becomes stuck in a particular state.

Therefore, there is a need for another solution to this problem.

### SUMMARY OF THE INVENTION

In accordance with the present invention, data processing circuits in a data processing system can be clocked based on the frequency or data rate of an external data stream. More specifically, a processor clock signal having a frequency that is an integer multiple of the frequency of the data stream is generated. The data processing circuits can be clocked based on this generated processor clock to achieve data processing that is synchronized with the external data stream without the aforementioned problems.

### BRIEF DESCRIPTION OF THE DRAWINGS

Aspects, advantages and novel features of the present invention will become apparent from the following description of the invention presented in conjunction with the accompanying drawings, wherein:

FIG. 1 is a generalized block diagram of a data processing system which embodies the present invention;

FIG. 2 shows is a generalized block diagram of an alternatively configured data processing system which embodies the present invention;

FIG. 3 is a specific embodiment of the present invention in a general video processing system;

FIGS. 4A and 4B are illustrative examples of the multiplier block shown in FIG. 3;

FIG. 5 shows an alternative configuration of the video processing system shown in FIG. 3;

FIG. 6 shows yet another alternative configuration of the video processing system shown n FIG. 3; and

FIGS. 7A and 7B illustrate typical prior art clocking arrangements.

### DESCRIPTION OF THE SPECIFIC EMBODIMENTS

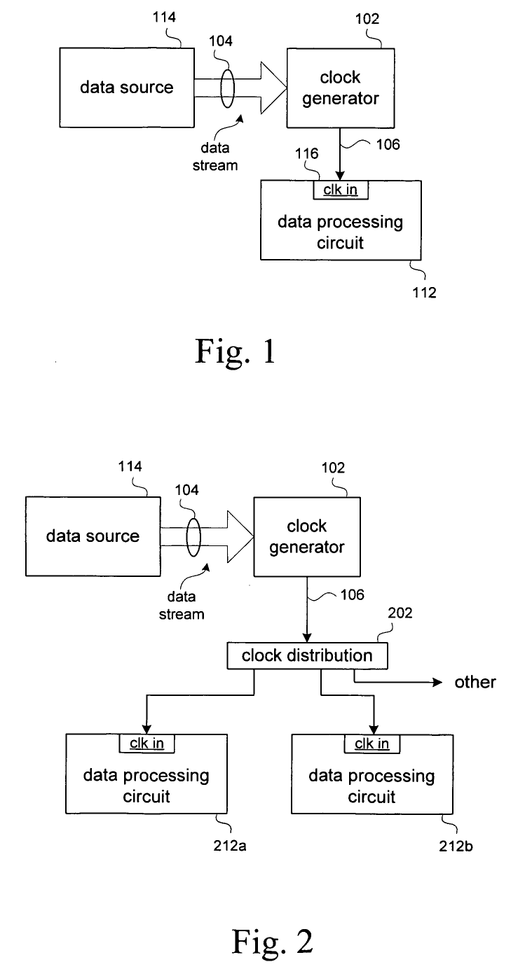

FIG. 1 is a generalized block diagram of a computer system embodying various aspects of the present invention. A data processing circuit 112 is provided. This can be any logic block that performs data processing and requires a clock signal to sequence through states of execution. In the context of the present invention, “digital processing” is broadly defined to include any sequential processing of digital data, that requires a clock signal to provide proper sequencing. The data processing circuit can be a conventional microprocessor, a digital signal processor, an FPGA (field programmable gate array), an ASIC (application specific IC), or any other such device that processes digital data and relies on a clock signal for proper synchronization. Typically, a digital processing circuit includes a “clock in” signal pin 116 for receiving a clocking signal.

FIG. 1 shows a data device 114 that produces a data stream 104. The data device 114 can be any source of the data stream 104. In accordance with the disclosed embodiment of the present invention, the device 114 is a video source; e.g., HD (high definition) digital video, Serial Digital interface (SDI), standard NTSC digital video, etc.

The data stream can be any form of digital data. For example, the data stream can be an audio data stream or a video data stream. The data stream can be textual data (e.g., ASCII characters), graphical data, and so on. The data stream is characterized by having a data rate. That is, the data is transmitted a rate of some number of bits per unit of time. Conventionally, the unit of measure is bits or bytes per second. Thus, for audio data the data rate might be 44Kbytes per second. Video data streams have different data rates for the different video formats that are available. For example, high definition (HD) digital video runs at a data rate of 1.485 Gbps (Giga-bits per second), while standard definition digital video uses a data rate of 270 Mbps.

The data stream 104 feeds into a clock generation circuit 102. The clock generation circuit 102 is configured to produce a clock signal 106 based on the data rate of the incoming data stream. The clock signal 106 is fed to the digital processor circuit 112 and thus serves to clock the digital processor circuit. Thus, in accordance with the present invention, the data processing circuit is clocked based at least on the data rate of the data stream. This includes integer multiples of the data rate as well as integer sub-multiples of the data rate. For example, if the data rate is m×n bits per second (where m and n are integers), then an “integer sub-multiple” of this data rate would be m bits per second. In the description of the embodiments of the present invention, it is understood that the term “integer multiple” will also include implementations that use “integer sub-multiples”.

The clock signal 106 that is produced is an integer multiple of the frequency (data rate) of the data stream 104. The data processing circuit is thereby clocked at a frequency that is related to the frequency which corresponds to (or is associated with) the data stream 104 by an integer multiple. This eliminates the need for a synchronizing circuit and the resulting errors due to meta-stable behavior of such circuits.

It will be understood that the “frequency” of the data stream and the “data rate” of the data stream can be used interchangeably in the context of the present invention. The frequency and the data rate are related measures of the bit rate in the data stream. For example, a data rate of 8 Mbits per second in an 8-bit data bus would require a clock frequency of 1 MHz.

FIG. 2 is a generalized block diagram of an alternatively configured computer system embodying the present invention. Here, the clock signal 106 feeds into a clock distribution circuit (clock driver) 202. This circuit is used to distribute a clock signal to various components 212a, 212b in the computer system. Typically, the clock distribution circuit 202 maintains the quality of the clock signal (e.g., ensuring a proper shape of the clock waveform) and to reduce clock skew.

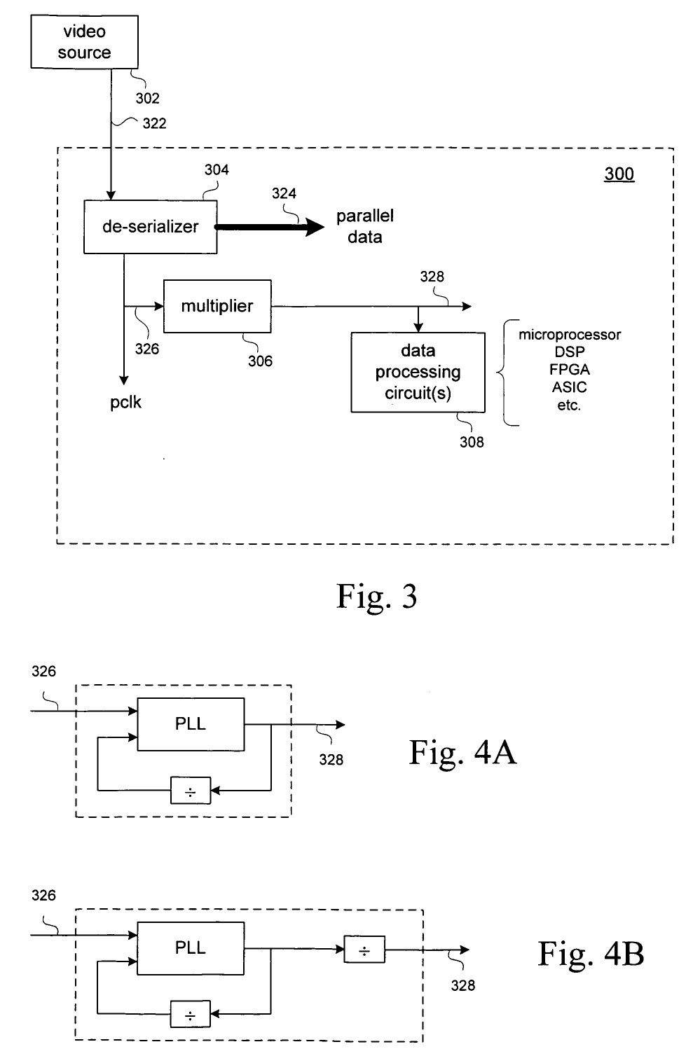

FIG. 3 shows a more specific embodiment of the present invention in a video processing system 300. The figure shows only those components of the video processing system 300 that are relevant to the discussion of the present invention. A video source 302 provides a digital video signal 322 to the video processing system 300, such as a serial data input (SDI) stream. The serial data stream of the digital video feeds into a de-serializer block 304 to convert the digital video into a parallel data stream 324. The parallel data is then routed within the video processing system 300 for subsequent processing.

The de-serializer 304 also produces a clock signal (pclk) 326 that is derived from the data rate of the incoming digital video 322. Thus, the frequency of this video-based clock signal 326 is determined from the data rate of the incoming digital video 322. The video-based clock signal 326 is multiplied by a multiplier block 306 to produce a generated clock signal 328. In accordance with the present invention, the multiplier block 306 is configured to generate a clock signal 328 having a frequency that is an integer multiple of the frequency of the video-based clock signal 326. Alternatively, the multiplier block 306 can be configured to generate a clock signal 328 having a frequency that is an integer sub-multiple of the frequency of the video-based clock signal 326; i.e., the frequency of the generated clock signal 328 is less than the frequency of the video-based clock signal 326 by an integer multiple.

The generated clock signal 328 is used to clock one or more digital processing circuits 308 in the video processing system 300. Thus, in accordance with the present invention, a microprocessor chip in the video processing system could be clocked by the generated clock signal 328. Moreover, all data processing circuits 308 comprising the video processing system 300 can be clocked by the generated clock signal 328. Since the frequency of the generated clock signal 328 is an integral multiple of the frequency of the video data 322, processing of the video data 322 by the data processing circuits which comprise the video processing system 300 will be inherently synchronous with the video data. A significant advantage of the present invention is therefore the elimination of metastable states which could result in missing incoming video data.

FIGS. 4A and 4B illustrate typical implementations of the multiplier block 306 shown in FIG. 3. A phase-locked loop (PLL) or a delay locked loop (DLL) are very well known and understood circuits that are conventionally used to increase the frequency of an incoming signal, thereby producing an output signal having higher frequency as well as maintaining a proper phase relationship. The incoming signal in the context of the disclosed embodiment of the present invention is the video-based clock signal 326 derived from the video data 322. The output signal is the generated clock signal 328 that can be used to clock the data processing circuits 308. The divider component shown in FIG. 4A can be configured to perform a divide-by-N operation, thus causing the multiplier block 306 to perform an N times multiplication on the incoming signal. FIG. 4B shows a divider circuit configured to perform a multiplication of the signal followed by a divider.

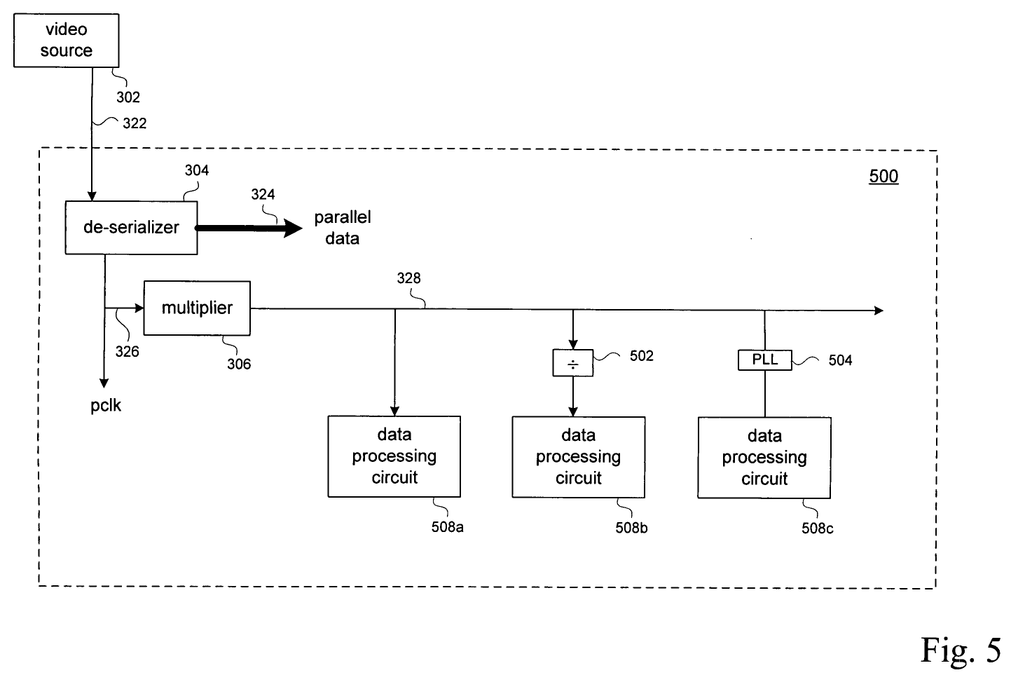

FIG. 5 shows an alternative configuration of the disclosed embodiment of the present invention. Where the elements in FIG. 5 are the same or similar to those shown in FIG. 3, the reference numerals from FIG. 3 are carried over into FIG. 5. In the configuration of FIG. 3, the generated clock signal 328 is shown being fed directly to the data processing circuits 308. In FIG. 5, it can be seen that the frequency of the generated clock signal 328 can be further multiplied to produce still higher frequency clock signals within the video processing system 500. Thus, the data processing circuit 508a is clocked directly by the generated clock signal 328.

The data processing circuit 508b is clocked by a signal that is produced after dividing the generated clock signal 328 by a divider circuit 502, thus dividing the frequency of the generated clock signal. In particular, the divider 502 performs an integer value division to ensure that the resulting lower frequency clock signal being fed into the data processing circuit 508b remains an integer multiple of the video data 322. The divider circuit 502 can be internal to the data processing circuit 508b, though in FIG. 5, it is shown as an external component.

The data processing circuit 508c is clocked by a signal that is produced by feeding the generated clock signal 328 into a PLL 504 (which has a divider in the feedback path to raise the frequency). This has the effect of multiplying the frequency of the generated clock signal 328. In particular, the PLL 504 performs an integer value multiplication of the input clock, resulting in a higher frequency clock signal that feeds into the data processing circuit 508c and remains an integer multiple of the video data 322. It can be appreciated of course that the PLL 504 can be an internal component of the data processing circuit 508c. More generally, the PLL functionality can be incorporated in the system in any suitable manner.

The configuration of FIG. 5 may be suitable where the processor clock rate needs to be different among the various data processing circuits in a video processing system. However, synchronous operation with respect to the incoming video data 322 is maintained by virtue of generating various processor clock signals whose frequencies are integer multiples of the frequency of the video data.

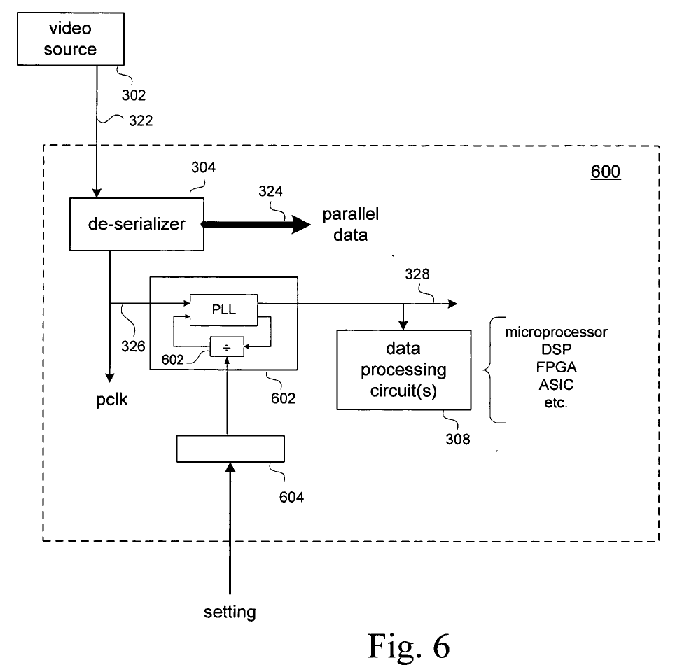

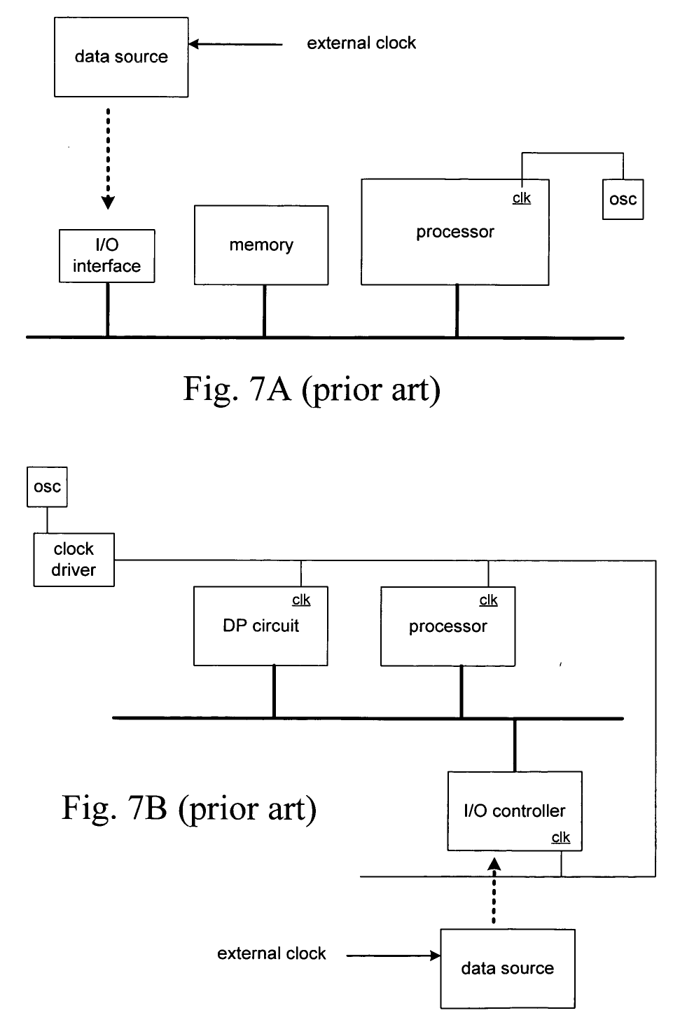

FIG. 6 shows yet a further aspect of the present invention, as embodied in a video processing system 600. Where the elements in FIG. 6 are the same or similar to those shown in FIG. 3, the reference numerals from FIG. 3 are carried over into FIG. 6. In FIG. 3, the multiplier block is shown generically as block 306. In the configuration of FIG. 6, a specific implementation of the multiplier block 602 is shown, namely, the use of a PLL. A register 604 or other suitable data store is provided. The contents of the register feeds into a programmable divider chip 606 in the feedback loop of the PLL. A range of frequencies of the generated clock signal 328 can thereby be produced by appropriately setting the contents of the register 604.

In one implementation, the register 604 can simply be jumper settings on a PC board on which components of the video processing system are assembled. When the system boots up, many initialization actions take place. One of them would be to read out the jumper settings of the “register” 604 and programmed into the divider chip 606.

In another implementation, the register 604 can be programmatically set by an application program executing in the video processing system. This would allow an application program to alter the processing speed of the various data processing circuits during operation of the video processing system. In this configuration, suitable reset/re-initialization operations would be performed to properly reset the various devices for subsequent operation at the new clock frequencies. Though not shown in FIG. 6, it is understood that additional registers such as register 604 can be provided to program other dividers or PLLs such as shown in FIG. 5.

What is claimed is:

1. A computer system configured for synchronous operation with a data source, the computer system comprising a synchronizing circuit configured to receive a data signal output by the data source and operative to generate a clocking signal based at least on a frequency of the data signal and a data processing circuit configured to operate at a clock rate based on the clocking signal, wherein the data processing circuit is clocked based at least on a frequency of the data signal.

2. The system of claim 1 wherein the clocking signal is an integral multiple of the frequency of the data signal.

3. The system of claim 1 wherein the clocking signal is an integral sub-multiple of the frequency of the data signal.

4. The system of claim 1 wherein the synchronizing circuit is programmable to generate a clocking signal having a selectable frequency.

5. The system of claim 1 wherein the data signal is one of video data or audio data.

6. The system of claim 1 wherein the data signal is one of digital text data or digital graphics data.

7. The system of claim 1 wherein the frequency of the data signal is determined by a data rate of the data signal.

8. A computer system comprising:
a signal input to receive a data signal, the data signal having data rate;
a first circuit coupled to the signal input and operative to produce a clock signal from the data signal, the first circuit having an output on which the clock signal is produced;
a data processor device having a clock input in electrical communication with the output of the first circuit, wherein a clock rate of the data processor device is based at least on the data rate of the data signal.

9. The system of claim 8 wherein the data rate of the data signal corresponds to a frequency and the frequency of the clock signal is either an integral multiple of the frequency of the data signal or an integral sub-multiple of the frequency of the data signal.

10. The system of claim 8 wherein the first circuit is a phase locked loop (PLL).

11. The system of claim 8 wherein the first circuit is a PLL, wherein a feedback loop thereof includes a programmable divider circuit.

12. The system of claim 11 wherein the divider circuit includes analog electronic components for setting a divider value thereof.

13. The system of claim 8 wherein the divider circuit is programmatically programmable.

14. The system of claim 8 wherein the data signal is one of digital video data, digital audio data, digital text data, or digital graphics data.

15. A computer system configured for synchronized operation with respect to a data signal, the computer system comprising a clocking circuit configured to receive the data signal and to generate a data clocking signal, a data processing circuit coupled to receive the data clocking signal from the clocking circuit and operative to produce one or more internal clocking signals based at least on the data clocking signal, wherein the data clocking signal is associated with a frequency that is an integer multiple of a frequency corresponding to the data signal, wherein processing of the data signal by the data processing circuit occurs at a frequency that is an integer multiple or an integer sub-multiple of the frequency associated with the data signal.

16. The system of claim 15 wherein the frequency of the data signal corresponds to a data rate of the data signal.

17. The system of claim 15 wherein the clocking circuit is programmable whereby the frequency of the data clocking signal can be selectively varied.

18. The system of claim 15 wherein the data signal is one of a digital video or digital audio.

19. The system of claim 15 wherein the data signal is a data stream of text or graphics data.

20. A method of synchronous operation of a data processor and a data device that sends a data stream to the data processor, the method comprising generating a clocking signal based at least on a frequency associated with the data signal and clocking the data processor with the clocking signal, the frequency of the clocking signal being related to the frequency associated with the data signal by an integer multiple.

21. The method of claim 20 wherein the frequency of the data stream corresponds to a data rate of the data stream.

22. The method of claim 20 wherein the frequency of the data stream is less than or equal to the frequency of the clocking signal.

23. The method of claim 20 wherein the frequency of the data stream is greater than or equal to the frequency of the clocking signal.

24. The method of claim 20 wherein the clocking signal is selectable.

25. The method of claim 20 wherein the data stream comprises a video data stream.

26. The method of claim 20 wherein the data stream comprises an audio data stream.

27. The method of claim 20 wherein the data stream comprises a text data stream.

28. The method of claim 20 wherein the data stream comprises a graphics data stream.

29. A method for synchronizing transmission of a data signal to a data processing device comprising generating a processor clocking signal based at least on the data signal and clocking the data processing device with the processor clock signal, the processor clocking signal having a frequency that is related to a frequency associated with the data signal by an integer multiple.

30. The method of claim 29 wherein the frequency of the data signal is less than or equal to the frequency of the clocking signal.

31. The method of claim 29 wherein the frequency of the data signal is greater than or equal to the frequency of the clocking signal.

32. The method of claim 29 wherein the frequency of the data signal corresponds to a data rate of the data signal.

33. The method of claim 29 further comprising generating a first clocking signal based at least on the frequency of the data signal and generating the processor clock signal further based on the first clocking signal, the first clocking signal having a frequency that is an integral multiple of the frequency of the data signal.

34. The method of claim 29 further comprising obtaining information indicative of a frequency setting, wherein the frequency of the processor clocking signal is further based on the frequency setting.

35. A method for synchronizing signal transmissions between an external device and a data processing device, the external device being external to and separate from the data processing device, the method comprising:
receiving an external signal transmitted from the external device to the data processing device;
determining a frequency associated with the external signal;
generating a clock signal based at least on the frequency that is associated with the external signal;
generating a processor clocking signal based at least on the clock signal; and
clocking the data processing device with the processor clocking signal.

36. The method of claim 35 wherein the determining includes driving a phase locked loop with the external signal.

37. The method of claim 35 wherein the clock signal has a frequency that is an integral sub-multiple of the frequency associated with external signal.

38. The method of claim 35 wherein the clock signal has a frequency that is an integral multiple of the frequency associated with external signal.

39. The method of claim 38 wherein the processor clocking signal has a frequency that is an integral multiple of the frequency of the clock signal.

40. The method of claim 38 wherein the processor clocking signal has a frequency that is an integral sub-multiple of the frequency of the clock signal.

41. The method of claim 35 wherein the external signal is a data stream, and the frequency of the external signal corresponds to a data rate of the data stream.
